(19) United States
(12) Patent Application Publication
(10) Pub. No.: US 2019/0297584 A1
(43) Pub. Date: Sep. 26, 2019

(54) User Device-Initiated Downlink Power Request

(71) Applicant: Google LLC, Mountain View, CA (US)

(72) Inventors: Erik Richard Stauffer, Sunnyvale, CA (US); Jibing Wang, Saratoga, CA (US)

(73) Assignee: Google LLC, Mountain View, CA (US)

(21) Appl. No.: 16/008,011

(22) Filed: Jun. 13, 2018

(51) Int. Cl. H04W 52/24; H04W 24/02; H04B 17/336

(52) U.S. Cl. CPC H04W 52/241; H04B 17/336; H04W 24/02

(57) ABSTRACT

The present disclosure describes techniques and systems for user device-initiated downlink power requests. Techniques for user device-initiated downlink power requests may include a user device using a signal quality of a downlink communication to optimize transmission power of the downlink communication. Based on this determination, the user device transmits, to a base station, a request to change a transmission power level for a future downlink communication. The base station can receive the request and, based on the request, adjust the transmission power level for a future communication.

### BACKGROUND

Generally, a provider of a wireless network manages wireless communications over the wireless network. For example, a base station manages a wireless connection with a user device that is connected to the wireless network. The base station determines configurations for the wireless connection, such as bandwidth, timing, and protocol for the wireless connection. The base station then transmits control messages to the user device to instruct the user device of the configurations for the wireless connection. Allowing the base station to determine the configurations for the wireless connection allows the base station to manage wireless connections with many wireless devices. However, without information related to conditions at the user device, the base station may choose suboptimal configurations for the wireless connection between the base station and the user device.

With recent advances in wireless communication technology, providers have access to higher-frequency radio spectrum, relative to conventional wireless deployments. This access coupled with other technologies enables wider bandwidth, lower latency, and increased data rates for wireless connections. However, wireless communication over wider bandwidths and in higher frequency bands can experience reduced network efficiency and have an increased susceptibility to interference from other wireless communications.

### SUMMARY

This document describes techniques for, and systems that enable, user device-initiated downlink power requests. These techniques may include a user device determining a signal quality, such as an observed signal-to-noise (SNR) ratio or observed signal-to-interference-plus-noise ratio (SINR), of a downlink communication. The determined signal quality can be used by the user device to optimize downlink transmission power. For example, transmission power may be higher than necessary for receiving future downlink communications using a current modulation and coding scheme (MCS) or aggregation level. Alternatively, the downlink transmission power detected by the user device may be too low for receiving future downlink communications with a different MCS that supports a higher data rate than the current MCS. The user device can provide, to the base station, a request to change the transmission power based on the determined transmission power. The base station can receive the request and adjust the transmission power level for a future communication.

In some aspects, a user device receives, via a wireless connection with a base station, a downlink communication over a channel of the wireless connection. The downlink communication is transmitted at a first transmission power level. The user device determines a signal quality of the received downlink communication over the channel of the wireless connection. Based on the signal quality, the user device determines a second transmission power level for a future downlink communication over the channel of the wireless connection. The user device then transmits, to the base station, a request to use the second transmission power level for the future downlink communication over the channel of the wireless connection. In some implementations, the user device receives the future downlink communication at a transmission power level that is different from the second transmission power level.

In other aspects, a user device includes a processor, a hardware-based transceiver, and a computer-readable storage medium including instructions that are executable by the processor to configure the processor to perform operations relating to user device-initiated downlink power requests. The operations include determining a SINR of a downlink communication from a base station over a channel of a wireless connection. The operations also include comparing the SINR of the downlink communication with a threshold SINR for an MCS. The operations further include determining, based on the comparison, a change in transmission power level to request for a future downlink communication over the channel of the wireless connection. The operations then include transmitting, to the base station and using the hardware-based transceiver, a request for the change in the transmission power level for the future downlink communication over the channel of the wireless connection.

In further aspects, a base station includes a processor, a hardware-based transceiver, and a computer-readable storage medium including instructions that are executable by the processor to configure the processor to perform operations relating to user device-initiated downlink power requests. The operations include transmitting, to a user device and using the hardware-based transceiver, a downlink communication over a channel of a wireless connection with the user device. The downlink communication is transmitted with a first transmission power level. The operations also include receiving, from the user device and using the hardware-based transceiver, a request for a second transmission power level for a future downlink communication. The operations further include transmitting, to the user device and using the hardware-based transceiver, the future downlink transmission. The future downlink transmission is transmitted at a third transmission power level that is based on the received request.

The details of one or more implementations are set forth in the accompanying drawings and the following description. Other features and advantages will be apparent from the description and drawings, and from the claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

The details of one or more aspects of user device-initiated downlink power requests is described below. The use of the same reference numbers in different instances in the description and the figures indicate similar elements:

FIG. 1 illustrates an example operating environment in which user device-initiated downlink power requests can be implemented.

FIG. 2 illustrates an example operating environment including wireless communication channels over which a user device and a base station may communicate in accordance with one or more aspects of user device-initiated downlink power requests.

FIG. 3 illustrates an example operating environment in which the user device and the base station may communicate in accordance with one or more aspects of user device-initiated downlink power requests.

FIG. 4 illustrates example signal strengths of a downlink communication and future downlink communications in accordance with one or more aspects of user device-initiated downlink power requests.

FIG. 5 illustrates an example user interface of the user device in accordance with one or more aspects of user device-initiated downlink power requests.

FIG. 6 illustrates an example method performed by the user device for user device-initiated downlink power requests.

FIG. 7 illustrates another example method performed by the user device for user device-initiated downlink power requests.

FIG. 8 illustrates an example method performed by the base station for user device-initiated downlink power requests.

### DETAILED DESCRIPTION

Base stations of wireless networks manage wireless connections with user devices by scheduling communication resources and determining configurations for communicating with the user devices. However, the base station may determine the configurations for the wireless connection without information related to conditions at the user device, which may lead to a suboptimal wireless connection or inefficient use of network resources. For example, the base station may configure a transmission power level for a downlink communication without data related to a signal strength of the downlink communication at the user device. This can result in excess transmission power levels, which can unnecessarily consume power at the base station, produce interference for other wireless connections, or reduce network efficiency.

This document describes techniques and systems for user device-initiated downlink power requests. Techniques for user device-initiated downlink power requests may include a user device determining a transmission power of a downlink communication based on a signal quality of the downlink communication. Based on this determination, the user device transmits, to a base station, a request to change a transmission power level for a future downlink communication. The base station can receive the request and, based on the request, adjust the transmission power level for a future communication.

In an illustrative implementation, a user device communicates with a base station over a wireless connection. The user device receives a downlink transmission of application data over a physical downlink shared channel (PDSCH) using an MCS. The user device determines a SINR of the downlink transmission and compares the SINR with a threshold SINR that is required to receive future downlink transmissions with using the MCS. Based on the comparison, the user device determines that the SINR is two dB above the threshold SINR. The user device then transmits, to the base station, a request to reduce a transmission power level by two dB. The base station can comply with the request or reduce a transmission power by an amount less than two dB. By reducing the transmission power level, the base station can reduce unnecessary power consumption, interference with other wireless connections, and improve network efficiency.

The following discussion describes an operating environment and techniques that may be employed in the operating environment and/or network environment. In the context of the present disclosure, reference is made to the operating environment or networking environment by way of example only.

Operating Environment

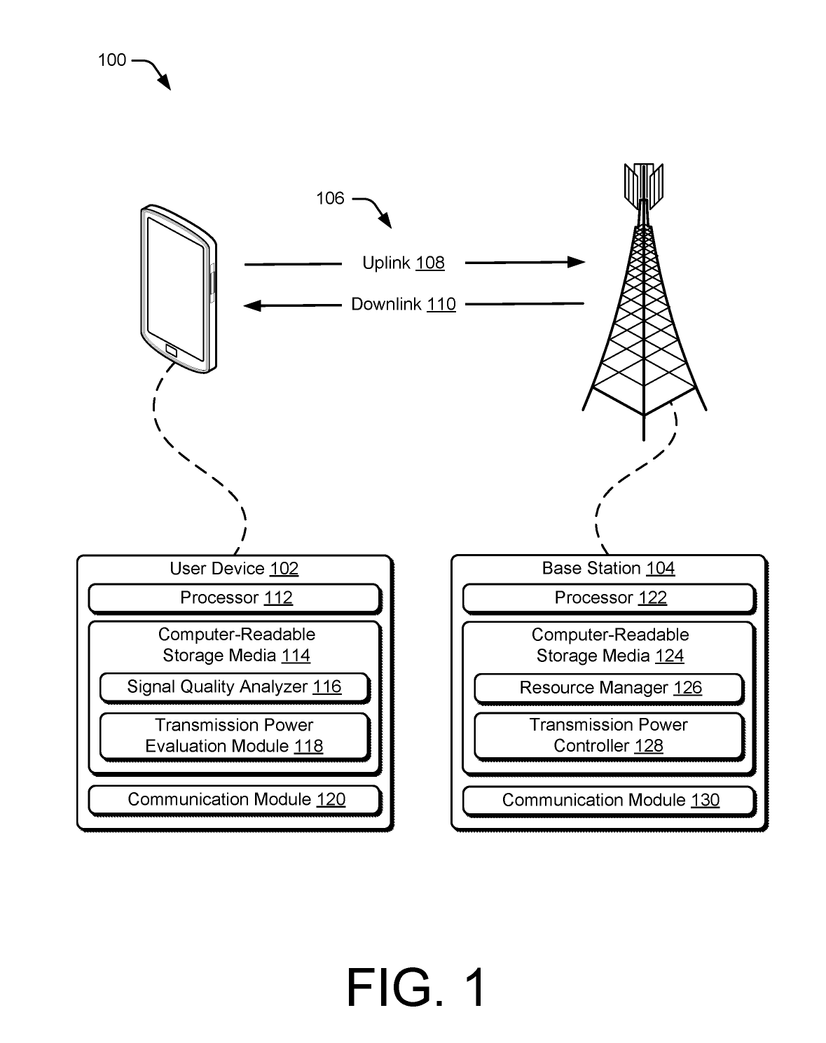

FIG. 1 illustrates an example operating environment 100 in which devices for user device-initiated downlink power requests can be implemented. In this example, the operating environment includes a user device 102 (or “user equipment” or “UE”) and a base station 104, which are respectively configured to communicate over a wireless connection 106 of a wireless network. Generally, the wireless connection 106 includes an uplink 108 by which the user device 102 transmits data to the base station 104 and a downlink 110 by which the base station 104 transmits other data to the user device 102. However, in some implementations, the wireless connection 106 may include only one of the uplink 108 or the downlink 110. Although shown or described with reference to a separate uplink 108 or downlink 110, communication between the user device 102 and the base station 104 may also be referenced as a wireless association, a frame exchange, a wireless link, or a communication link.

The wireless connection 106 may be implemented in accordance with any suitable protocol or standard, such as a Global System for Mobile Communications (GSM), Worldwide Interoperability for Microwave Access (WiMax), a High Speed Packet Access (HSPA), Evolved HSPA (HSPA+) protocol, a Long Term Evolution (LTE) protocol, an LTE Advanced protocol, a Fifth Generation (5G) New Radio (NR) protocol, or a future advanced protocol. The protocol may operate based on frequency division duplexing (FDD) or time division duplexing (TDD). The wireless connection 106 may operate over a high bandwidth, such as a bandwidth greater than 1 GHz. Further, the wireless connection 106 may be configured to allow for operation at high frequencies, such as frequencies above 3 GHz, as well as lower frequencies, such as those between 0.5 GHz and 3 GHz. More specifically, the wireless connection 106 may be configured to operate in a millimeter wave frequency range.

The user device 102 includes a processor 112, computer-readable storage media (CRM) 114 that includes a signal quality analyzer 116 and a transmission power evaluation module 118, and a communication module 120. The user device 102 is illustrated as a smart phone, however the user device 102 may instead be implemented as any device with wireless communication capabilities, such as a mobile gaming console, a tablet, a laptop, an advanced driver assistance system (ADAS), a point-of-sale (POS) terminal, a health monitoring device, an unmanned aircraft, a camera, a media-streaming dongle, a wearable smart-device, an internet-of-things (IoT) device, a personal media device, a navigation device, a mobile-internet device (MID), a wireless hotspot, a femtocell, a smart vehicle, or a broadband router.

The processor 112 of the user device 102 can execute processor-executable instructions or code stored by the CRM 114 to cause the user device 102 to perform operations or implement various device functionalities. In this example, the CRM 114 also stores processor-executable code or instructions for implementing one or more of the signal quality analyzer 116 or the transmission power evaluation module 118 of the user device 102.

A processor, such as the processor 112, can be implemented as an application processor (e.g., multicore processor) or a system-on-chip with other components of the user device 102 integrated therein. A CRM, such as the CRM 114, may include any suitable type of memory media or storage media, such as read-only memory (ROM), programmable ROM (PROM), random access memory (RAM), static RAM (SRAM), or Flash memory. In the context of this discussion, a CRM is implemented as hardware-based storage media, which does not include transitory signals or carrier waves. In some cases, a CRM stores one or more of firmware, an operating system, or applications of an associated device as instructions, code, or information. The instructions or code can be executed by an associated processor to implement various functionalities of the associated device, such as those related to network communication.

The signal quality analyzer 116 determines a signal quality metric for a received downlink communication using sensing circuitry embedded in the communication module 120. In some implementations, the signal quality analyzer 116 can determine absolute measurements of one or more of a noise level, an interference level, or the received signal strength (RSSI) of the downlink communication. In other implementations, the signal quality analyzer 116 makes relative measurements of the ratio of a received downlink communication signal level to one or both of noise or interference, such as a measurement of an SNR or an SINR.

The transmission power evaluation module 118 can use the signal quality to determine an different transmission power level for future downlink transmissions by the base station 104. For example, the transmission power evaluation module 118 may compare the signal quality to a threshold for receiving the future downlink communications using a desired MCS or aggregation level. The desired MCS or aggregation level may be the same MCS or aggregation level as the received downlink communication, or another MCS or aggregation level. The desired MCS may depend on a type of communication, or a channel for communication, of the future downlink communication. In an example implementation, the measured signal quality is four dB above the threshold for the same MCS as the received downlink communication. The transmission power evaluation module 118 can determine that the transmission power can be reduced by four dB. Alternatively, the transmission power evaluation module 118 may determine that if the transmission power is increased by two dB, the future communication can be transmitted using a different MCS that provides a higher data rate than the MCS currently in use. In these situations, the transmission power evaluation module 118 may determine that the transmission power can be increased by four dB to use the MCS that provides the higher data rate.

The communication module 120 of the user device 102 includes a hardware-based transceiver and associated circuitry, software, or other components for wirelessly communicating with the base station 104. The communication module 120 includes one or more of antennas, a radio frequency (RF) front end, an LTE transceiver, or a 5G NR transceiver for communicating with base station 104 or other base stations. The RF front end of the communication module 120 can couple or connect one or both of the LTE transceiver or the 5G NR transceiver to the antennas to facilitate various types of wireless communication. The antennas of the communication module 120 may include an array of multiple antennas that are configured similarly to or differently from each other. The antennas and the RF front end can be tunable to one or more frequency bands defined by the 3GPP LTE or 5G NR communication standards and implemented by one or both of the LTE transceiver or the 5G NR transceiver. The circuitry in the communication module 120 also includes sensing circuitry and associated logic or executable code to measure downlink radio signals received by the user device 102. By way of example and not limitation, the antennas and the RF front end can be implemented for operation in sub-gigahertz bands, sub-6 GHZ bands, and/or above 6 GHz bands that are defined by the 3GPP LTE or 5G NR communication standards. Alternatively, the 5G NR transceiver may be replaced with a 5G NR receiver.

The communication module 120 may transmit, via a transmitter of the transceiver, data to the base station 104 via one or more radio frequency channels of the uplink 108, such as a physical random access channel (PRACH), a physical uplink control channel (PUCCH), or a physical uplink share channel (PUSCH). This data transmitted to the base station 104 may include any suitable type of framed or packetized information, an uplink control information (UCI) communication, a radio resource control (RRC) message, a sounding reference signal (SRS), a PRACH communication, device status information, wireless connection status information, wireless connection control information, data requests, application data, or network access requests. The communication module 120 may also receive, via a receiver of the transceiver, other data from the base station 104 over one or more channels of the downlink 110, such as a physical downlink control channel (PDCCH), a PDSCH, or a physical hybrid automatic repeat request (HARQ) indicator channel (PHICH). The other data may include one or more of application data, a page, downlink pilots, primary or secondary synchronization signals (PSSs or SSSs), a master information block (MIB), a system information block (SIB), a downlink control information (DCI) message, an RRC message, a downlink grant, an uplink grant, wireless connection configuration settings, network control information, or a communication mode selection.

In this example, the base station 104 is shown generally as a cellular base station of a wireless network. The base station 104 may be implemented to provide and manage a cell of a wireless network that includes multiple other base stations that each manage another respective cell of the wireless network. As such, the base station 104 may communicate with a network management entity or others of the multiple base stations to coordinate connectivity or hand-offs of mobile stations within or across the cells of the wireless network.

The base station 104 can be configured as any suitable type of base station or network management node, such as a GSM base station (e.g., a Base Transceiver Station, a BTS), a node base (Node B) transceiver station (e.g., for UMTS), an Evolved Universal Terrestrial Radio Access Network Node B (E-UTRAN Node B, evolved Node B, eNodeB, eNB, e.g., for LTE), or a Next Generation Node B (gNode B, or gNB, e.g., for 5G NR). As such, the base station 104 may control or configure parameters of the uplink 108 or the downlink 110 in accordance with one or more of the wireless standards or protocols described herein.

The base station 104 includes a processor 122, a computer-readable storage media (CRM) 124 including a resource manager 126 and a transmission power controller 128, and a communication module 130. In this example, the CRM 124 also stores processor-executable code or instructions for implementing the resource manager 126, and the transmission power controller 128 of the base station 104.

In some aspects, the resource manager 126 of the base station 104 is implemented to perform various functions associated with allocating physical access (e.g., resource blocks) or communication resources for the air interface of the base station 104. The air interface of the base station 104, may be partitioned or divided into various units (e.g., frames, subframes, or slots) of one or more of bandwidth, time, symbols, or spatial layers. For example, within a framework of a 5G NR protocol, the resource manager 126 can allocate bandwidth and time intervals of access in resource blocks, each of which may be allocated in whole, or in part, to one or more channels for communicating with the user device 102. As discussed above, the channels may include one or more of a PRACH, a PUCCH, a PUSCH, a PDCCH, a PDSCH, a PHICH, or a paging channel. The resource blocks may include multiple subcarriers that each span a portion of a frequency domain of the resource blocks. The subcarriers may be further divided into resource elements, or orthogonal frequency-division multiplexing (OFDM) symbols, that each span a portion of a time domain of the subcarriers. Consequently, a resource block includes multiple OFDM symbols that can be grouped into subcarriers with other OFDM symbols having a common frequency bandwidth.

In some aspects, the transmission power controller 128 configures transmission power levels for communication with one or more user devices, such as the user device 102. Further, the transmission power controller 128 may configure different transmission power levels for one or more various types of communications. For example, the transmission power controller 128 may configure a relatively lower transmission power level for control messages and a relatively higher transmission power level for application data, such as video streaming In other examples, the transmission power controller 128 may configure different transmission power levels for one or more wireless channels. In some of these implementations, the transmission power controller 128 may configure a relatively low transmission power level for transmissions over a PDCCH and a relatively high transmission power level for transmission over a PDSCH.

The transmission power controller 128 may also configure the different transmission power levels based on feedback from the user device 102. For example, the transmission power controller 128 may configure the transmission power levels based on a user device-initiated downlink power request. In some implementations, the transmission power controller 128 configures initial transmission power levels, receives a user device-initiated downlink power request to change to another transmission power level, and then reconfigures the transmission power levels to the other transmission power level. The user device-initiated downlink power request may indicate a relative change to a transmission power level, such as a request to increase the transmission power level by two dB. Additionally or alternatively, the user device-initiated downlink power request may include one or more different requested transmission power levels for various types of communications, communication bandwidths, communication data rates, or wireless channels of the wireless connection 106.

The communication module 130 includes a hardware-based transceiver that includes a receiver, a transmitter, and associated circuitry or other components for communicating with the user device 102 via the wireless medium. The communication module 130 may be configured to communicate over one or more frequency bandwidths of the wireless medium and over multiple spatial layers and beams. In some cases, the communication module 130 includes, or is coupled with, multiple hardware-based transceivers and antenna arrays that are configured to establish and manage wireless connections with multiple user devices over one or more frequency bandwidths and communication resources. The base station 104 may communicate, over one or more channels, any suitable data with the user device 102 through the uplink 108 and the downlink 110, such as a schedule of allocated communication resources, downlink pilots, application data, wireless connection status information, or wireless connection control information.

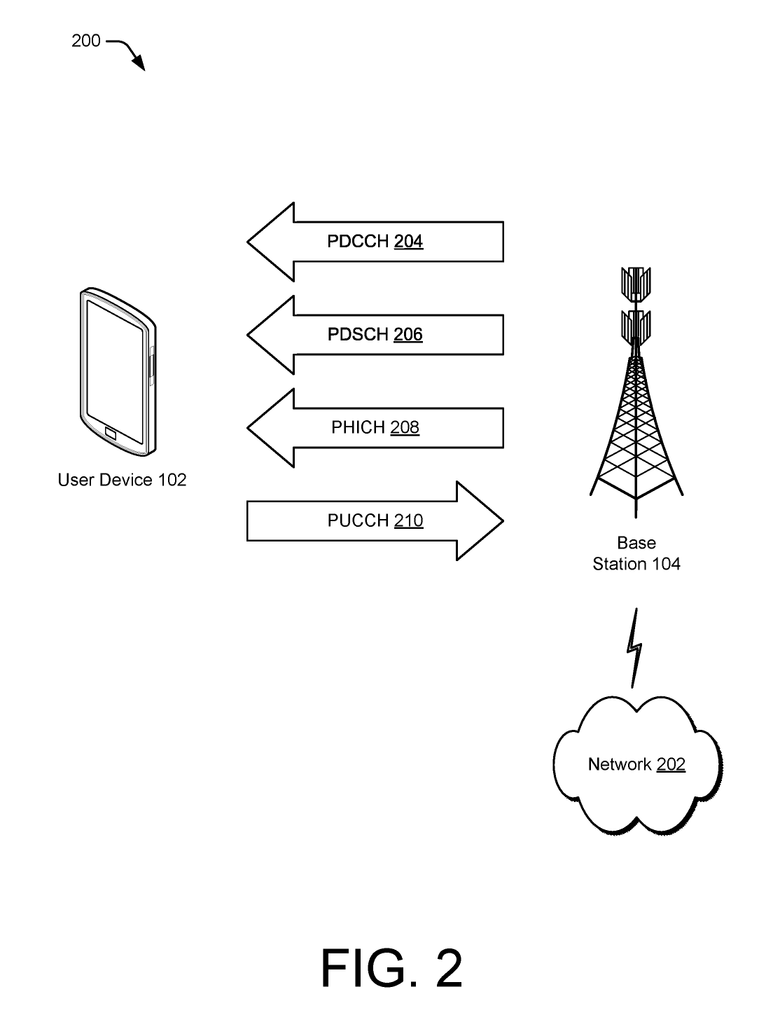

FIG. 2 illustrates an example operating environment 200 including wireless communication channels over which a user device 102 and a base station 104 may communicate in accordance with one or more aspects of user device-initiated downlink power requests. The network environment includes respective instances of the user device 102 and the base station 104, which provides a wireless network with which the user device 102 and other user devices 102 may connect. Through the wireless network, the base station 104 may enable or provide access to other networks or resources, such as a network 202 (e.g., the Internet) connected via a backhaul link (e.g., fiber network). Additionally or alternately, the operating environment 200 may include other base stations or a mobility manager, such as a mobility management entity (MME) or an access and mobility management function (AMF), to provide an area wide wireless network, such as a 5G NR network and associated data services.

The user device 102 and/or the base station 104 may communicate through any suitable type or combination of channels, message exchanges, or network management procedures. In this example, the wireless connection 106 includes one or more channels such as, but not limited to, a PDCCH 204, a PDSCH 206, a PHICH 208, or a PUSCH 210.

The PDCCH 204 can be used by the base station 104 to communicate, to the user device, one or more control messages, such as downlink control information (DCI) messages, medium access control (MAC) control elements (CEs), or RRC messages. In some aspects, the control messages include an identification of resource elements or a confirmation of a receipt of a user device-initiated power control request to be used for communication of data to the user device 102. The control messages may also include an MCS and coding/decoding information for the user device 102 to access the data communicated to the user device 102. The control messages may further identify another MCS that is available for future communications. Additionally or alternatively, the control messages may enable or disable user device-initiated downlink power requests. Communications over the PDCCH 204 may have relatively low data content and may therefore be transmitted with a relatively low MCS.

The PDSCH 206 may be used by the base station 104 to transmit application data to the user device 102. The PDSCH 206 may be used for transmissions having a relatively high data content such as application data, data downloads, video streaming, or other large file data transfers. Therefore, transmissions over the PDSCH 206 may be transmitted with a relatively high MCS to facilitate a relatively high data rate. In some implementations, the PDSCH 206 may also be used for transmissions of control messages, such as a MAC CE.

The base station 104 may send additional data to the user device 102 via the PHICH 208. The PHICH 208 includes acknowledgements or lack of acknowledgements for data received from the user device 102 via a PUSCH. The PHICH 208, like the PDCCH 204, is configured to facilitate transmissions having a relatively low data content and may therefore be transmitted with a relatively low MCS. The MCS of the PHICH 208 and the MCS of the PHICH 208 may both be lower than an MCS of the PDSCH 206. For example, the MCS of the PDCCH 204 and the PHICH 208 may be quadrature phase-shift keying (QPSK) and the MCS of the PDSCH 206 may be 64 quadrature amplitude modulation (QAM) or 256 QAM.

The PUCCH 210 may be useful to transmit, to the base station 104, one or more of HARQ acknowledge/not acknowledge (ACK/NACK), channel quality indicators (CQI), multiple-input-multiple-output (MIMO) feedback such as a rank indicator (RI) or a precoding matrix indicator (PMI), or scheduling requests for uplink transmission. In the context of user device-initiated downlink power requests, the user device may transmit a power control request via the PUCCH 210. The request may include a request for a downlink transmission power level or a relative increase or decrease from a current downlink transmission power level. The power control request may indicate different requested transmission power levels for one or more of the PDCCH 204, the PDSCH 206, or the PHICH 208. The base station 104 determines whether to adjust a current transmission power level based on the power control request. Based on the determination, the base station 104 configures the communication module 130 to transmit future downlink transmissions.

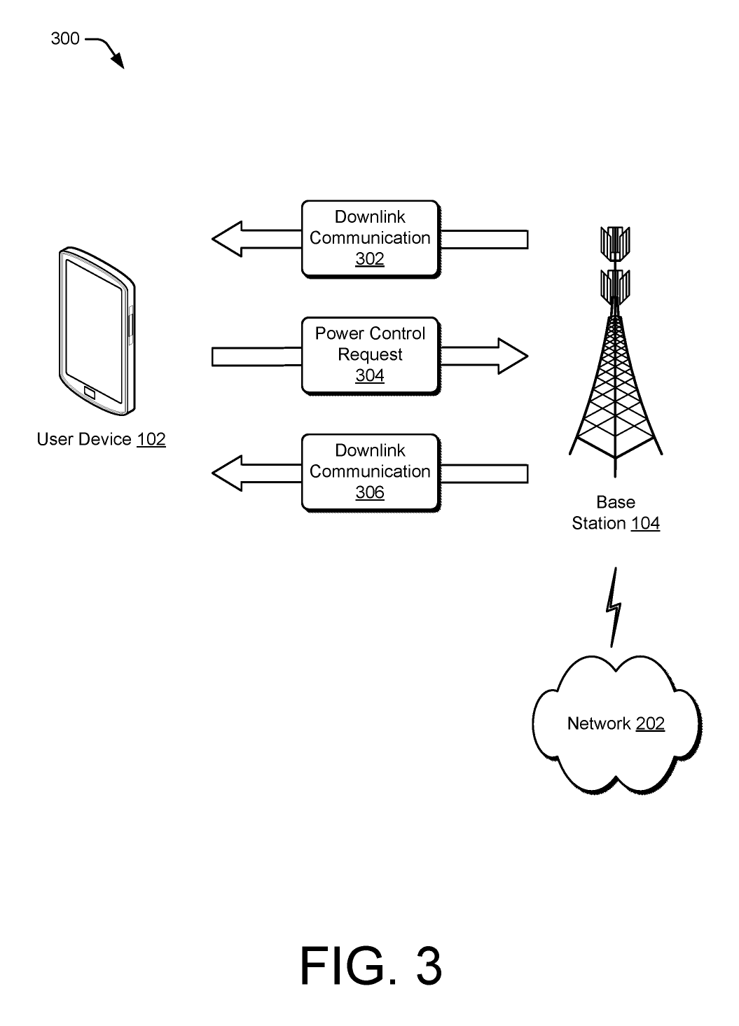

FIG. 3 illustrates an example operating environment 300 in which the user device and the base station may communicate in accordance with one or more aspects of user device-initiated downlink power requests. The network environment includes respective instances of the user device 102, the base station 104, and the network 202.

In this example, the base station 104 transmits a downlink communication 302 to the user device 102. For example, the base station 104 transmits application data with an MCS of 64 QAM to the user device 102 over the PDSCH 206. In response to receiving the downlink communication 302, the user device 102 analyzes a signal quality of the downlink communication 302. For example, the user device 102 may determine an SNR or an SINR and compare the signal quality with thresholds for various configurations of an MCS. The user device 102 may then determine a different transmission power level.

The user device 102 transmits a power control request 304 to the base station 104 to request a change of transmission power level from a transmission power level of the downlink communication 302 to the different transmission power level. The power control request 304 may indicate the different transmission power level as a defined transmission power level or as a change in transmission power level relative to the power level of the downlink communication 302. The power control request 304 may indicate a request to change a transmission power level of one or more channels of the wireless connection 106 and may further request different transmission power levels for various channels of the wireless connection 106, such as the PDCCH, the PDSCH 206, the PHICH 208, or a channel state information-reference signal (CSI-RS). Additionally or alternatively, the power control request 304 may indicate a request to change a transmission power level for a portion of a channel of the wireless connection 106, such as a frequency bandwidth or a time-range of the channel The user device 102 may transmit the power control request 304 via the wireless connection 106, a wireless connection using another radio access technology, or a supplemental uplink. The power control request 304 may be included in a UCI communication, an RRC message, or a MAC CE.

In response to receiving the power control request 304, the base station 104 configures the communication module 130 for transmitting a future downlink transmission at a transmission power level that is different from that of the downlink communication 302. The configured transmission power level may be based on the power control request 304. For example, the power control request 304 may request an increase of three dB and the base station 104 may increase the transmission power level by four dB to include one dB of margin above a minimum signal strength for the future downlink transmission, as observed by the user device 102. Further, the configured transmission power level may conform to the power control request 304 by configuring the transmission power level to a level identified in the power control request 304.

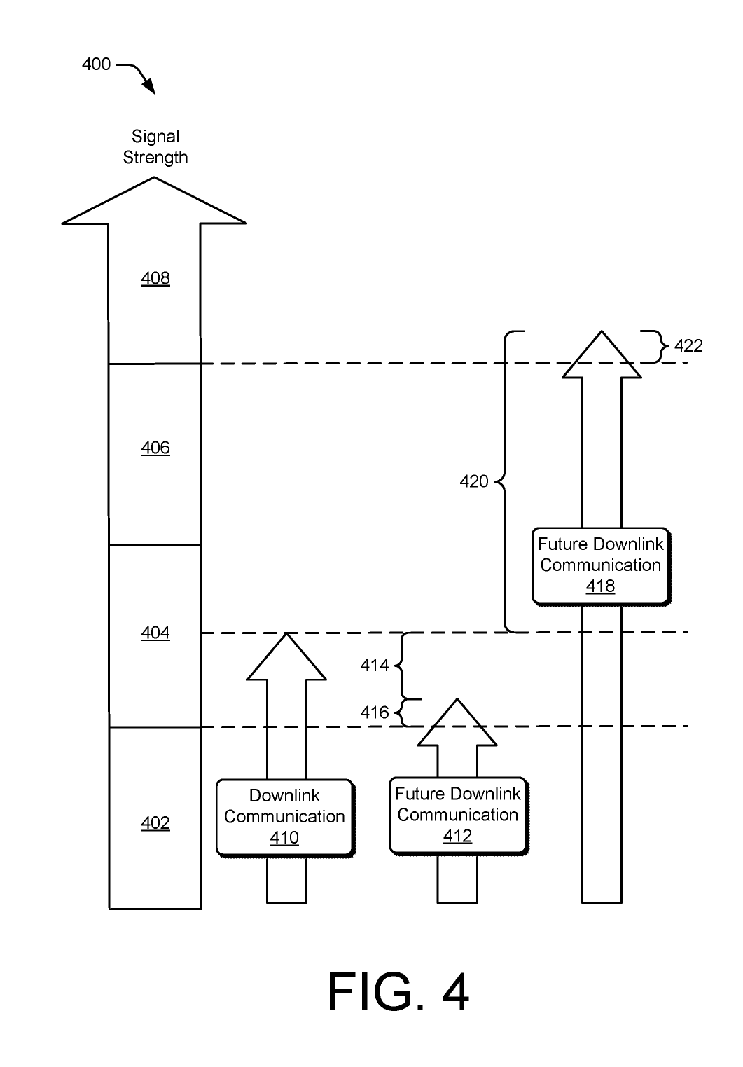

FIG. 4 illustrates example signal strengths 400 of a downlink communication and future downlink communications in accordance with one or more aspects of user device-initiated downlink power requests. A signal strength spectrum includes portions 402, 404, 406, and 408 that support various types of modulation and coding schemes. For example, the portion 402 may be a range of signal strengths over which a QPSK MCS is usable, the portion 404 may be a range of signal strengths over which a 16-QAM MCS is usable, the portion 406 may be a range of signal strengths over which 64-QAM MCS is usable, and the portion 408 may be a range of signal strengths over which 256-QAM MCS is usable. A signal strength in a higher range may also allow for an MCS described as usable in a lower range. For example, a signal strength in the portions 404, 406, or 408 may also allow for an MCS described as usable for the portion 402.

In this example, the user device 102 receives a downlink communication 410, such as the downlink communication 302. The downlink communication 410 has a signal strength within the portion 404. The user device 102 may determine that an MCS useable in the portion 404 is sufficient for a future downlink communication 412. In this case, the user device 102 determines that the downlink communication 410 is received with a greater signal strength than the minimum signal strength that is required and that a transmission power can be reduced for the future downlink communication 412 while maintaining adequate signal strength within the portion 404. The user device 102 determines a change 414 in transmission power level for the future downlink communication. The change 414 in transmission power level may account for a margin 416 above a minimum signal strength of the portion 404. The user device 102 may then transmit the power control request 304 and receive the future downlink communication 412 from the base station 104.

Alternatively, the user device 102 may determine that a higher-modulation MCS would be available if a signal strength of a future downlink communication 418 is increased. In this case, the user device 102 determines a change 420 in signal strength that would allow use of the higher-modulation MCS. The user device 102 determines an increase of transmission power level to achieve the change 420 in signal strength. The change 420 in signal strength may include a margin 422 above a minimum signal strength of the portion 404. The user device 102 may then transmit the power control request 304 and receive the future downlink communication 418.

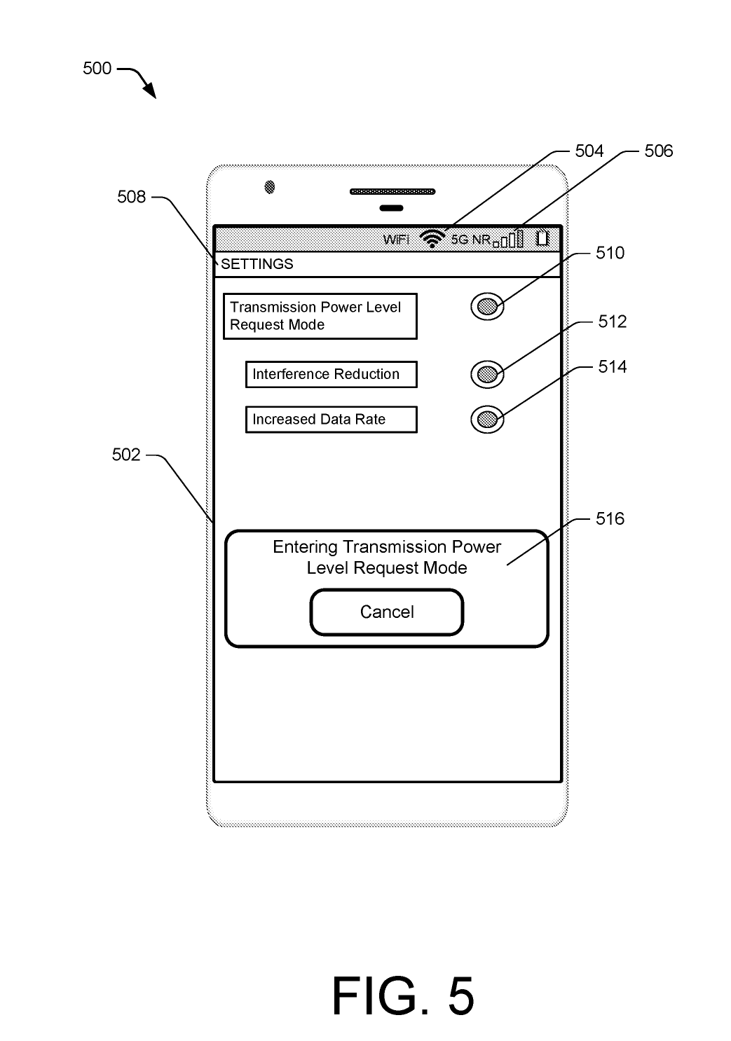

FIG. 5 illustrates an example user interface 500 of an instance of the user device 102 through which one or more aspects of user device-initiated downlink power requests can be implemented. In this example, the user interface 500 is presented through a visible portion of a display 502 for providing output to a user. The display 502 may also include, or be integrated with, a touch screen or touch-sensitive overlay for receiving touch input from the user. The display 502 may also display one or more of an indicator 504 of another wireless connection of the user device 102 or an indicator 506 of a signal quality of the wireless connection 106 (shown as 5G NR).

In some implementations, the display 502 provides or makes accessible a settings menu 508 through which the user interface 500 can receive input 510 to select a transmission power level request mode. The settings menu 508 can receive additional inputs 512 or 514 to select one or more modes for user device-initiated downlink power requests. The inputs 512 or 514 select example modes including interference reduction, and increased data rate, respectively. For example, the interference reduction mode may prioritize reduction of excess signal strength to reduce interference with the other wireless connection of the user device 102. The increased data rate mode may prioritize increasing a signal quality to a level at which a highest usable modulation MCS is available for the wireless connection 106 or a channel of the wireless connection 106. A highest usable modulation MCS may be different among different channels of the wireless connection 106. For example, a highest usable MCS for the PDCCH may be a low-data-rate MCS relative to a highest usable MCS for the PDSCH.

Additionally or alternatively, the user device 102 may provide a notification 516 via the user interface 500 to indicate that the user device 102 is entering the transmission power level request mode, based on user input. The notification 516 is illustrated in this example as a pop-up notification in the display 502, however, other forms of the notification 516 may be implemented in addition or in alternative to the pop-up notification. For example, the user device 102 may provide an audible notification, a visible notification via a light emitting diode (LED) indicator that is separate from the display 502, or a motion-based notification such as a vibration of the user device 102.

The user interface 500 is but one of many possible user interfaces for implementing user device-initiated downlink power requests. Although the user device 102 is illustrated as a smart phone with a touch screen, alternative user interfaces may be implemented by the user device 102. For example, the user device 102 may be implemented as a laptop with a user interface. The user interface of the laptop may include, for example, one or more of a mouse, a track pad, a keyboard, a microphone, a monitor, a projector screen, or speakers. In some implementations, the user interface does not include the settings menu 508 for receiving the inputs 510, 512, or 514, but rather, the user device 102 enters the transmission power level request mode automatically and without receiving user input.

Techniques for User Device-Initiated Downlink Power Requests

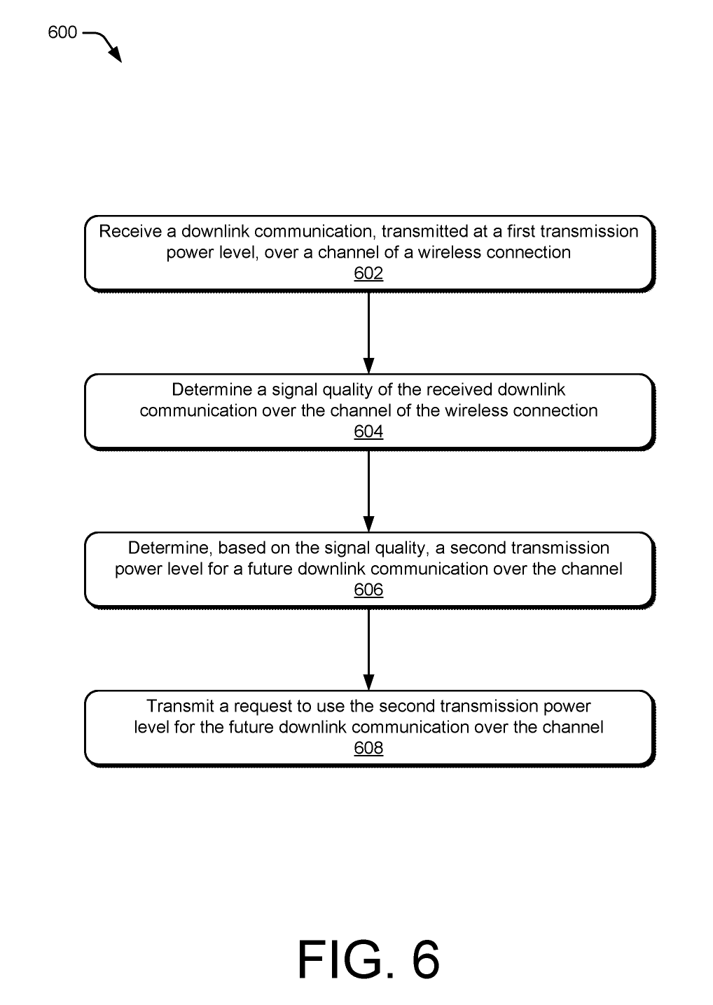

FIGS. 6-8 depict methods for implementing user device-initiated downlink power requests. These methods are shown as sets of blocks that specify operations performed but are not necessarily limited to the order or combinations shown for performing the operations by the respective blocks. For example, operations of different methods may be combined, in any order, to implement alternate methods without departing from the concepts described herein. In portions of the following discussion, the techniques may be described in reference to FIGS. 1-5, reference to which is made for example only. Generally, any of the components, modules, methods, and operations described herein can be implemented using software, firmware, hardware (e.g., fixed logic circuitry), manual processing, or any combination thereof. The techniques are not limited to performance by one entity or multiple entities operating on one device, or those described in these figures.

FIG. 6 illustrates an example method 600 performed by a user device for implementing user device-initiated downlink power requests. The method 600 includes operations that may be performed by a signal quality analyzer, such as the signal quality analyzer 116, a transmission power evaluation module, such as the transmission power evaluation module 118, and a communication module, such as the communication module 120. In some aspects, operations of the method 600 may optimize transmit power for a downlink transmission to improve the efficiency of network resource utilization or reduce interference for other wireless connections.

At operation 602, the user device receives a downlink communication, transmitted at a first transmission power level, over a channel of a wireless connection. For example, the user device 102 receives, from the base station 104, the downlink communication 410 over a channel of the wireless connection 106. The downlink communication 410 is transmitted at a first transmission power level.

At operation 604, the user device determines a signal quality of the received downlink communication over the channel of the wireless connection. For example, the signal quality analyzer 116 of the user device 102 determines a signal quality of the received downlink communication 410. The signal quality may be determined as a signal-to-noise ratio or a signal-to-interference-plus-noise ratio, for example. In some of these cases, the signal quality analyzer 116 may determine reception conditions at the user device 102. For example, the reception conditions may include noise, interference, expected noise, or expected interference.

At operation 606, the user device determines, based on the signal quality, a second transmission power level for a future downlink communication over the channel of the wireless connection. For example, transmission power evaluation module 118 of the user device 102 determines a second transmission power level for one of the future downlink communication 412 or 418. The second transmission power level may reduce an amount of transmission power used while maintaining enough transmission power to support use of an MCS of the downlink communication of operation 602. Alternatively, the second transmission power level may sufficient to allow the use of an MCS that provides a higher data rate. Further, the second transmission power level may be a transmission power level that is expected to produce a signal strength above a minimum signal strength, at the user device, to use a same modulation and coding scheme (MCS) as an MCS of the received downlink communication. Alternatively, the second transmission power level may be a transmission power level that is expected to produce a signal strength above a minimum signal strength, at the user device, to use a modulation and coding scheme (MCS) that provides a higher data rate than an MCS of the received downlink communication.

At operation 608, the user device transmits a request to use the second transmission power level for the future downlink communication over the channel of the wireless connection. For example, the user device 102 transmits the power control request 304 to the base station 104. The power control request 304 may request a transmission power level that is lower than the first transmission power level or higher than the first transmission power level. The power control request 304 may include a requested change to another transmission power level for another future downlink communication over another channel For example, the power control request 304 may request a change to the first transmission power level for a future transmission over the PDCCH and another transmission power level for another future transmission over the PDSCH. Additionally or alternatively, the second transmission power level may include a transmission power level for a first portion of the channel and a different transmission power level for a second portion of the channel.

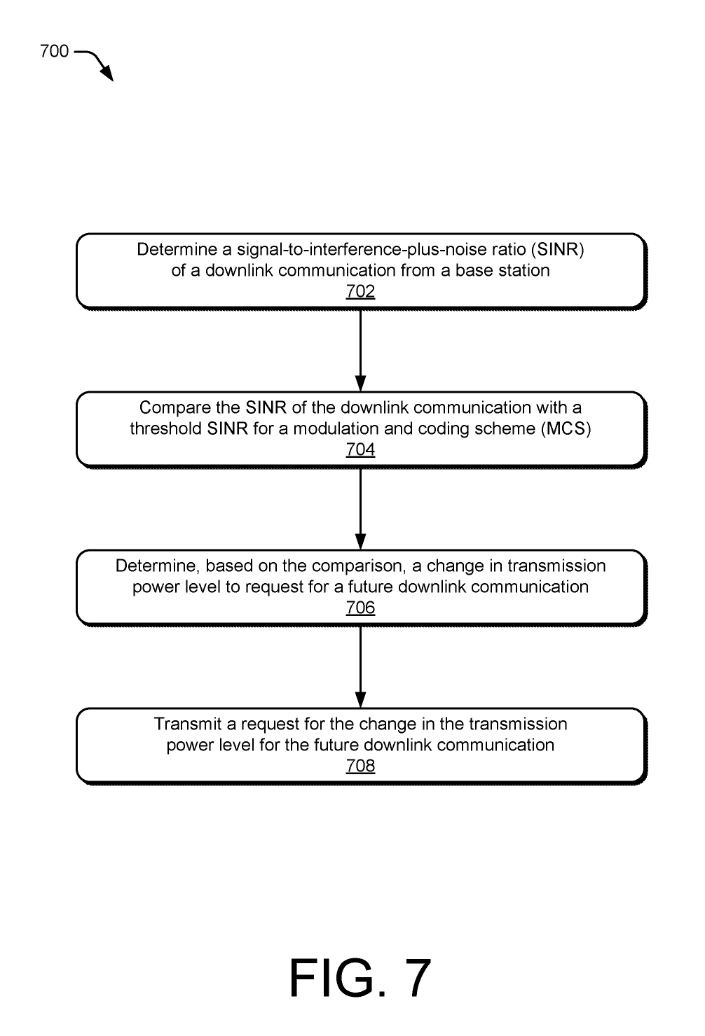

FIG. 7 illustrates an example method 700 performed by a user device for implementing user device-initiated downlink power requests. The method 700 includes operations that may be performed by a signal quality analyzer, such as the signal quality analyzer 116, a transmission power evaluation module, such as the transmission power evaluation module 118, and a communication module, such as the communication module 120. In some aspects, operations of the method 700 may optimize power utilization for a downlink transmission, improve the efficiency of network resource utilization or reduce interference for other wireless connections based on a power control request provided by the user device 102 to the base station 104.

At operation 702, the user device determines an SINR of a downlink communication from a base station over a channel of a wireless connection. For example, the signal quality analyzer 116 of the user device 102 determines a signal quality of the downlink communication 410 received, from the base station 104, over a channel of the wireless connection 106. The SINR is determined as observed at the user device 102.

At operation 704, the user device compares the SINR of the downlink communication with a threshold SINR for an MCS. For example, one of the signal quality analyzer 116 or the transmission power evaluation module 118 compares the SINR of the downlink communication 410 with threshold SINR for an MCS. The threshold may be a low end of one of the portions 402, 404, 406, or 408. Alternatively, the threshold may be a margin 416 or 422 above the low end of one of the portions 402, 404, 406, or 408.

At operation 706, the user device determines, based on the comparison, a change in transmission power level to request for a future downlink communication. For example, the transmission power evaluation module 118 determines an increase or a decrease in transmission power level that the user device 102 can request for one of the future downlink communications 412 or 418. The change may include a relative change in transmission power level relative to a transmission power level of the downlink communication. The change in transmission power level may be based on a threshold SINR for successful reception of the future communication using an MCS. The MCS may be an MCS with an increased data rate relative to an original MCS of the downlink communication.

At operation 708, the user device transmits a request for the change in the transmission power level for the future downlink communication. For example, the user device transmits the power control request 304 to the base station 104 to request a change a transmission power level from that of the downlink communication 302. As described herein, the power control request may be transmitted on another wireless connection, a supplemental uplink, or on the wireless connection.

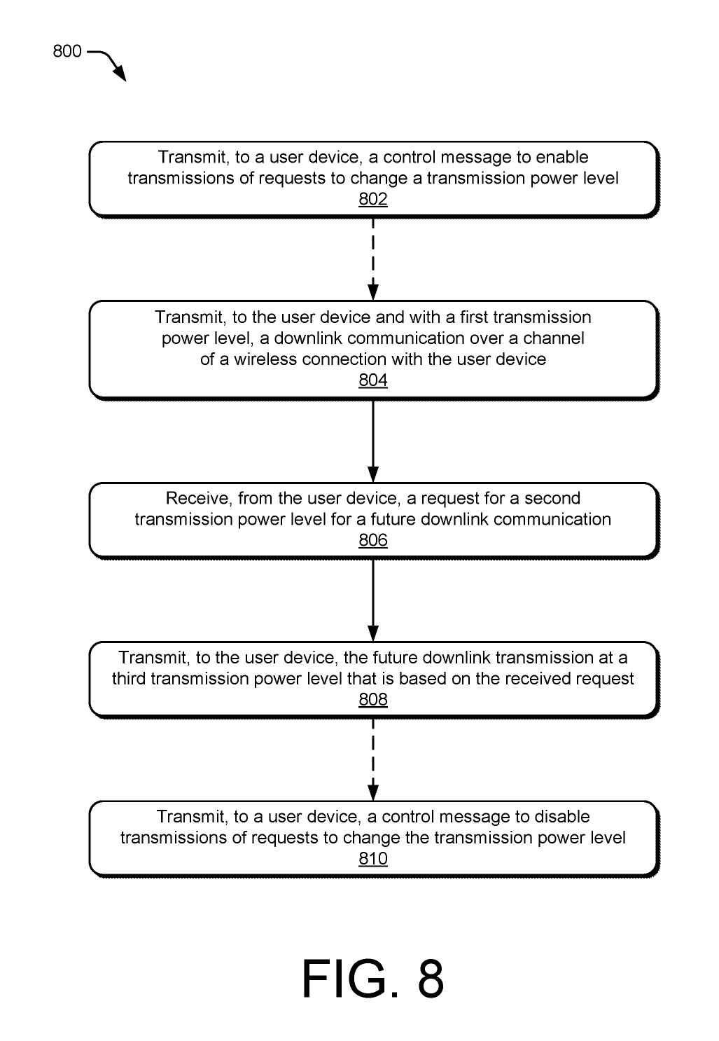

FIG. 8 illustrates an example method 800 performed by a base station for implementing user device-initiated downlink power requests. The method 800 includes operations that may be performed by a resource manager, such as the resource manager 126, a transmission power controller, such as the transmission power controller 128, and a communication module, such as the communication module 130. In some respects, operations of the method 800 may improve power utilization for a downlink transmission, improve network efficiency or reduce interference for other wireless connections.

At optional operation 802, the base station transmits, to a user device, a control message to enable transmissions of requests to change a transmission power level. For example, the base station 104 transmits one of an RRC message, a DCI message, or a MAC CE. The control message may further indicate a protocol for a response by the user device 102 to transmit a power control request 304. This may include an indication of communication resources for transmitting the power control request 304.

At operation 804, the base station transmits to the user device and with a first transmission power level, a downlink communication over a channel of a wireless connection with the user device. For example, the base station transmits, with a first transmission power level, the downlink communication 302 over a channel of a wireless connection 106.

At operation 806, the base station receives, from the user device, a request for a second transmission power level for a future downlink communication. For example, the base station 104 receives the power control request 304 requesting a change from the transmission power level of the downlink communication 410. The power control request 304 may request a change in transmission power level that corresponds to one of the change 414 or 420 in signal strength from that of the downlink communication 410 to one of the future downlink communications 412 or 418.

At operation 808, the base station transmits, to the user device, the future downlink transmission at a third transmission power level that is based on the received request. For example, the base station 104 transmits, to the user device 102, the downlink communication 306 at a transmission power level that is based on the power control request 304. The transmission power level of the future downlink transmission may be increased or decreased relative to the first transmission power level. Additionally or alternatively, the transmission power level of the future downlink transmission may be increased or decreased relative to the second transmission power level as requested by the user device 102. In some implementations, when the second transmission power level is higher than the first transmission power level, the third transmission power level is also higher than the first transmission power level. Additionally or alternatively, when the second transmission power level is lower than the first transmission power level, the third transmission power level is also lower than the first transmission power level.

Although techniques using, and apparatuses for implementing, user device-initiated downlink power requests have been described in language specific to features and/or methods, it is to be understood that the subject of the appended claims is not necessarily limited to the specific features or methods described. Rather, the specific features and methods are disclosed as example ways in which user device-initiated downlink power requests can be implemented.

What is claimed is:

1. A method performed by a user device for user device-initiated downlink power requests in a wireless communication network, the method comprising:
receiving, via a wireless connection with a base station, a downlink communication over a channel of the wireless connection, the downlink communication transmitted at a first transmission power level;
determining a signal quality of the received downlink communication over the channel of the wireless connection;
determining, based on the signal quality, a second transmission power level for a future downlink communication over the channel of the wireless connection; and
transmitting, to the base station, a request to use the second transmission power level for the future downlink communication over the channel of the wireless connection.

2. The method as recited in claim 1, wherein:
the second transmission power level is lower than the first transmission power level; and
the method further comprising receiving, from the base station, the future downlink communication transmitted with a transmission power level that is lower than the first transmission power level.

3. The method as recited in claim 1, wherein:
the second transmission power level is higher than the first transmission power level; and
the method further comprising receiving, from the base station, the future downlink communication transmitted with a transmission power level that is higher than the first transmission power level.

4. The method as recited in claim 1, wherein the determining the signal quality includes determining a signal-to-interference-plus-noise ratio (SINR) of the received downlink communication.

5. The method as recited in claim 1, wherein
the transmitted request includes a requested to use a third transmission power level for another future downlink communication over another channel; and
the third transmission power level is a different transmission power level than the second transmission power level.

6. The method as recited in claim 1, wherein the second transmission power level includes a transmission power level for a first portion of the channel and a different transmission power level for a second portion of the channel.

7. The method as recited in claim 1, wherein the second transmission power level is a transmission power level expected to produce a signal strength above a minimum signal strength, at the user device, to use a same modulation and coding scheme (MCS) as a MCS of the received downlink communication.

8. The method as recited in claim 1, wherein the second transmission power level is a transmission power level expected to produce a signal strength above a minimum signal strength, at the user device, to use a modulation and coding scheme (MCS) that has a higher data rate than a MCS of the received downlink communication.

9. The method as recited in claim 1, wherein the determining the signal quality includes determining reception conditions at the user device.

10. The method as recited in claim 1, wherein the request indicates a relative change of transmission power level from the first transmission power level.

11. A user device comprising:
a processor;
a hardware-based transceiver; and
a computer-readable storage medium comprising instructions executable by the processor to configure the processor to:
determine a signal-to-interference-plus-noise ratio (SINR) of a downlink communication from a base station over a channel of a wireless connection;
compare the SINR of the downlink communication with a threshold SINR for a modulation and coding scheme (MCS);
determine, based on the comparison, a change in transmission power level to request for a future downlink communication over the channel of the wireless connection; and
transmit, to the base station and using the hardware-based transceiver, a request for the change in the transmission power level for the future downlink communication over the channel of the wireless connection.

12. The user device as recited in claim 11, wherein the request indicates a change in transmission power level relative to a transmission power level of the downlink communication.

13. The user device as recited in claim 11, wherein the change in transmission power level is based on a threshold SINR for successful reception of the future downlink communication using a first modulation and coding scheme (MCS).

14. The user device as recited in claim 13, wherein the first MCS is an MCS with an increased data rate relative to a second MCS of the downlink communication.

15. The user device as recited in claim 11, wherein the instructions are executable by the processor to configure the processor to transmit the request via another wireless connection that is different from the wireless connection.

16. A base station comprising:
a processor;
a hardware-based transceiver; and
a computer-readable storage medium comprising instructions executable by the processor to configure the processor to:
transmit, to a user device and using the hardware-based transceiver, a downlink communication over a channel of a wireless connection with the user device, the downlink communication transmitted with a first transmission power level;
receive, from the user device and using the hardware-based transceiver, a request for a second transmission power level for a future downlink communication; and
transmit, to the user device and using the hardware-based transceiver, the future downlink transmission, the future downlink transmission transmitted at a third transmission power level that is based on the received request.

17. The base station as recited in claim 16, wherein the instructions are executable by the processor to configure the processor to transmit, before the reception of the request, a control message to enable transmissions of requests for transmission power levels.

18. The base station as recited in claim 16, wherein the instructions are executable by the processor to configure the processor to transmit, after the reception of the request, a control message to disable transmissions of requests for transmission power levels.

19. The base station as recited in claim 16, wherein the third transmission power level is an increased transmission power level relative to the first transmission power level.

20. The base station as recited in claim 15, wherein the third transmission power level is a same transmission power level as the second transmission power level.
